(19) United States
(12) Patent Application Publication
(10) Pub. No.: US 2004/0033348 A1
(43) Pub. Date: Feb. 19, 2004

(54) Laminar shaped body

(76) Inventor: Michael Bopp, Witten (DE)

Correspondence Address: VENABLE, BAETJER, HOWARD AND CIVILETTI, LLP, P.O. BOX 34385, WASHINGTON, DC, 20043-9998, US

(21) Appl. No.: 10/433,654

(22) PCT Filed: Dec. 7, 2001
(86) PCT No.: PCT/EP01/14406

(30) Foreign Application Priority Data
Dec. 7, 2000 (DE) 200 20 712.1

(51) Int. Cl. B32B 3/00; B29C 70/30; B29C 71/02; B32B 27/00; B27N 3/10; B32B 3/26

(52) U.S. Cl. 428/304.4; 264/257; 264/258; 264/236; 442/370; 428/316.6; 428/317.9; 428/318.4; 428/319.3

(57) ABSTRACT

The invention relates to a laminated shaped body having a defined layer structure, and to a method for its preparation, comprising a laminated shaped body (1) having a layer structure of the following order:

a) a support medium (2);

b) a matrix foam material (3) filled with fibrous material and determining the structural strength;

c) a semipermeable intermediate layer (4); and

d) a predetermined blank of a semirigid foam material (5).

The invention relates to a laminated shaped body having a defined layer structure, and to a method for its preparation.

In the prior art, a number of laminated shaped bodies for the preparation of vehicle interior trim parts have already been proposed. They usually have a multilayer structure.

DE 43 21 225 A1 describes a sheet-like trim part for motor vehicles, such as roof linings or the like, with a core layer comprising one or more plies and two exterior layers of a natural fiber sheet covering the core layer and connected with it by one adhesive layer each, characterized in that the adhesive layers consists of epoxy resin foam and that the exterior layers exclusively consist of a loosely needled material, as well as methods, especially for the preparation of such a trim part.

DE 24 18 849 OS relates to a flexible absorbing structure having a top layer of polymeric foam which is permeable to liquids and an underlying layer of a liquid-absorbing material and a bottom film of a flexible moisture-impermeable material, characterized in that the polymeric foam is a compressed foam of an addition polymer made from an aqueous polymeric latex, the layer of the compressed foam having a thickness of about 0.0254 to about 0.254 mm.

DE 297 13 267 relates to a multilayer composite material, especially for the sound-absorbing screening of the engine compartment of motor vehicles, characterized by a first cover layer made of a non-woven material, a first interior layer of foam and a second cover layer made of a non-woven material.

DE 42 26 988 A1 relates to a molded part made of natural fibers impregnated with a foamed artificial resin, consisting of two exterior layers of natural fibers arranged in one or more predetermined directions and a middle layer which is sandwiched by the exterior layers and at least partly formed by the foamed artificial resin. Due to the arrangement of the natural fibers in predetermined directions, the molded part obtains a higher loadability.

DE 20 49 978 OS relates to a method for the preparation of a porous laminate consisting of at least one support layer of textile, leather or the like, at least one foam layer of polyurethane and at least one cover layer, wherein open-cell polyurethane foam having a density of foam of less than 100 kg/cm³ is connected with the support layer and densified to between 2 and 25% of the initial thickness, and provided with the cover layer.

EP 0 650 828 A1 relates to a laminate having a sheet-like support part made of a solidified basic non-woven with a content of thermoplastic fibers, provided on at least one side thereof with a plastic-containing cover layer, characterized in that the basic non-woven is connected with the cover layer by the application of pressure and heat through an intermediate layer with a thermoplastic fraction whose material is different from or the same as that of the plastic fibers of the basic non-woven, and whose softening temperature is above that of the plastic fibers of the basic non-woven, as well as methods for the preparation thereof, and the use thereof.

However, in a first embodiment, the object of the present invention is to provide a laminates shaped body, especially for interior trims of motor vehicles, having a multilayer structure with integrated acoustically active surfaces and regions for absorbing shock energy.

In a first embodiment, the above object is achieved by a laminated shaped body 1 having a layer structure of the following order:

a) a support medium 2;

b) a matrix foam material 3 filled with fibrous material and determining the structural strength;

c) a semipermeable intermediate layer 4; and

d) a predetermined blank of a semirigid foam material 5.

The laminated shaped body 1 according to the invention has a semipermeable intermediate layer along which the expansion of the matrix foam material 3 proceeds. At the same time, a small amount of the matrix material 3 penetrates this intermediate layer and thus provides for the bonding of the in-laid blank of a semirigid foam material 5. Under the pressure and the temperature of the mold, the blank of the semirigid foam material 5 is additionally deformed and, in places, densified to achieve the concrete shaping and to design a possible surface for later use.

The laminated shaped body 1 according to the invention can be obtained, for example, by:

a) placing a fibrous material determining the structural strength in the form of mats or blanks on a support medium 2;

b) providing the surface of the fibrous material with an expandable matrix material;

c) followed by placing thereon a semipermeable intermediate layer 4 and subsequently a blank of a semirigid foam material 5; and

d) curing the laminated body 1 in a mold at a temperature within a range of from 40 to 120° C.

Another embodiment of the present invention relates to a method.

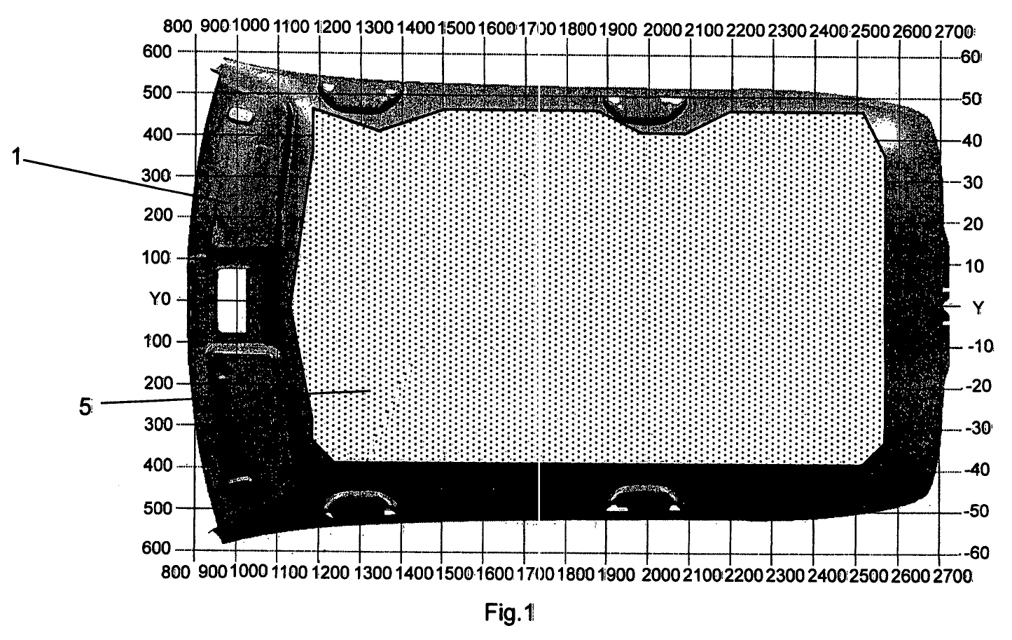

FIG. 1 shows a top view of a laminated shaped body 1 according to the invention in which the region of the predetermined blank of a semirigid foam material 5 is represented by a dotted area.

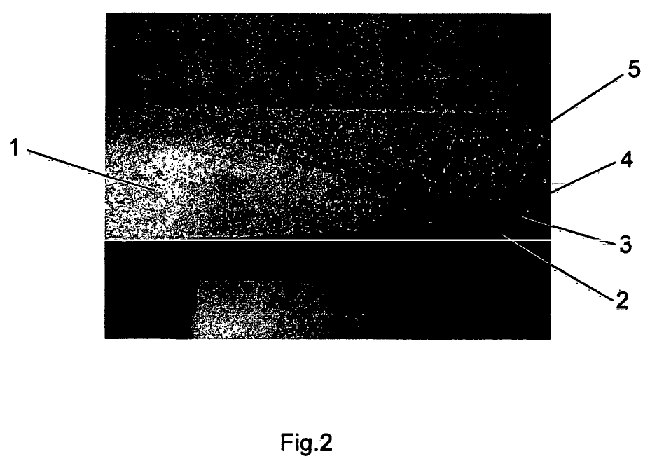

FIG. 2 shows a cross-sectional view through a laminated body 1 according to the invention in which it can be seen that the matrix foam material 3 filled with fibrous material and determining the structural strength penetrates the semipermeable intermediate layer in a particular region and causes the bonding with the semirigid foam material 5. At the same time, the semirigid foam blank 5 is deformed and, in places, densified under the pressure and the temperature of the mold by the action of the matrix foam material 3.

In a preferred embodiment of the present invention, the support medium 2 is preferably prepared from paper, plastic sheet or a non-woven material. The physico-chemical properties of this support medium 2 are of a lesser importance because it essentially serves to remove the laminated shaped body from the mold. In contrast, the matrix foam material 3 determines the structural strength of the laminated foam body 1. Therefore, it is particularly preferred according to the present invention for this matrix material 3 to be prepared on the basis of a two-component material, such as polyurethane, epoxide or polyester resin.

It is particularly preferred according to the present invention that the fibrous material is coated by a spraying or casting method or coated with cut fibers of glass and/or natural fibers in the form of a direct coating by known methods with the liquid matrix material 3, depending on the later use.

Accordingly, the fibrous material comprises, in particular, fibers of glass and/or natural fibers, said natural fibers being preferably selected from sisal, hemp, jute, flax and/or cotton.

In regions with a high uptake of shock energy, the laminated shaped body 1 according to the invention preferably has a higher density as compared to regions with a low energy uptake. This can be realized, for example, by adapting the distribution of the composition for the matrix foam material 3 in its raw state to the local uptake of shock energy. Thus, it is possible to make the distribution of the composition in such a way that a higher proportion of matrix material 3 is present in the regions having a high uptake of shock energy for obtaining these regions when the matrix material 3 is supplied. Thus, a higher filling volume of expanded matrix 3 can be obtained.

Subsequent to the matrix foam material 3, there is a semipermeable layer 4 in the laminated shaped bodies 1 according to the invention. Through the semipermeable layer 4, which may be prepared, for example, from paper, plastic sheets, nonwoven materials or similar covers, expansion proceeds along these interfaces and regulates them by the quantity supplied.

As a further layer of the laminated shaped body 1 according to the invention, there is the blank of a semirigid foam material 5, which preferably consists of a polyurethane semirigid foam. It is particularly preferred according to the present invention to employ a blank of a semirigid foam 5 having a density within a range of from 10 to 30 kg/cm³.

After the layers have been placed on one another, the above arrangement is cured in a mold at a temperature adapted to the process, preferably within a range of from 40 to 120° C.

A further embodiment of the present invention relates to a method for preparing a laminated shaped body, characterized by:

a) placing a fibrous material determining the structural strength in the form of mats or blanks on a support medium 2;

b) providing the surface of the fibrous material with an expandable matrix material;

c) followed by placing thereon a semipermeable intermediate layer 4 and subsequently a blank of a semirigid foam material 5; and

d) curing the laminated shaped body 1 in a mold at a temperature within a range of from 40 to 120° C.

In a further process step, the laminated shaped body 1 according to the invention may then be backed with a decorative surface, for example, a decorative layer 6, especially of textile, in order that the acoustically effective layer of the semirigid foam 5 is maintained.

However, direct backing may also be performed in an analogous process step by employing the decorative layer 6 with a barrier sheet 7. However, the acoustic effectiveness of the laminated shaped body 1 is reduced thereby.

1. A laminated shaped body (1) having a layer structure of the following order:
a) a support medium (2) consisting of paper, a plastic sheet or a nonwoven material;
b) a matrix foam material (3) filled with fibrous material and determining the structural strength and consisting of expanded polyurethane, epoxy or polyester resin, wherein said fibrous material comprises fibers of glass and/or natural fibers selected from sisal, hemp, jute, flax and/or cotton;
c) a semipermeable intermediate layer (4) consisting of paper, a plastic sheet or a non-woven material; and
d) a predetermined blank of a semirigid foam material (5) comprising a polyurethane semirigid foam having a density within a range of from 10 to 30 kg/m³.

2. The laminated shaped body (1) according to claim 1, characterized in that said matrix foam material (3) has a higher density in regions with a high uptake of shock energy as compared to regions with a low uptake of shock energy.

3. The laminated shaped body (1) according to claim 1, characterized in that the distribution of the composition for the matrix foam material (3) in its raw state is adapted to the local uptake of shock energy.

4. The laminated shaped body (1) according to any of claims 1 to 3, characterized by further comprising
e) a decorative layer (6), especially of a textile material.

5. The laminated shaped body (1) according to claim 4, characterized in that said decorative layer (6) is backed with said blank of semirigid foam material (5) through a barrier sheet (7).

6. The laminated shaped body (1) according to any of claims 1 to 5, characterized by the following steps, performed in a single operation:
a) placing a fibrous material determining the structural strength in the form of mats or blanks on a support medium (2) consisting of paper, a plastic sheet or a non-woven material, wherein said fibrous material comprises fibers of glass and/or natural fibers selected from sisal, hemp, jute, flax and/or cotton;
b) providing the surface of the fibrous material with an expandable matrix material consisting of polyurethane, epoxy or polyester resin;
c) followed by placing thereon a semipermeable intermediate layer (4) consisting of paper, a plastic sheet or a non-woven material, and subsequently a blank of a semirigid foam material (5) comprising a polyurethane semirigid foam, especially one having a density within a range of from 10 to 30 kg/m³; and
d) curing the laminated shaped body (1) in a mold at a temperature within a range of from 40 to 120° C.;
optionally followed by backing with a decorative surface in a further operation.

7. A method for preparing a laminated shaped body (1) according to any of claims 1 to 12, characterized by the following steps, performed in a single operation:
a) placing a fibrous material determining the structural strength in the form of mats or blanks on a support medium (2) consisting of paper, a plastic sheet or a non-woven material, wherein said fibrous material comprises fibers of glass and/or natural fibers selected from sisal, hemp, jute, flax and/or cotton;
b) providing the surface of the fibrous material with an expandable matrix material consisting of polyurethane, epoxy or polyester resin;
c) followed by placing thereon a semipermeable intermediate layer (4) consisting of paper, a plastic sheet or a non-woven material, and subsequently a blank of a semirigid foam material (5) comprising a polyurethane semirigid foam, especially one having a density within a range of from 10 to 30 kg/m³; and
d) curing the laminated shaped body (1) in a mold at a temperature within a range of from 40 to 120° C.;
optionally followed by backing with a decorative surface in a further operation.
